(19) United States
(12) Patent Application Publication
(10) Pub. No.: US 2026/0306947 A1
(43) Pub. Date: Oct. 8, 2026

(54) RELEASING METHOD FOR SKILL IN GAME, ELECTRONIC DEVICE, AND NON-TRANSITORY COMPUTER-READABLE STORAGE MEDIUM

(71) Applicant: NETEASE (HANGZHOU) NETWORK CO., LTD., Hangzhou, Zhejiang (CN)

(72) Inventor: Zhangjun CHEN, Hangzhou, Zhejiang (CN)

(73) Assignee: NETEASE (HANGZHOU) NETWORK CO., LTD., Hangzhou, Zhejiang (CN)

(21) Appl. No.: 19/108,239

(22) PCT Filed: Jun. 16, 2023
(86) PCT No.: PCT/CN2023/100822

§ 371 Date: Mar. 3, 2025

(30) Foreign Application Priority Data
Sep. 1, 2022 (CN) 202211071831.9

(51) Int. Cl. A63F 13/537; A63F 13/426; A63F 13/5258

(52) U.S. Cl. CPC A63F 13/537; A63F 13/426; A63F 13/5258

(57) ABSTRACT

A releasing method for a skill in a game, includes: in response to a trigger operation for a target skill, displaying a skill indicator corresponding to the target skill, and controlling the skill indicator to follow the trigger operation and move in the graphical user interface; in response to the skill indicator moving to an edge position, adjusting a camera orientation of the virtual camera from a first camera orientation to a second camera orientation according to the trigger operation, and adjusting the first game screen to a second game screen while maintaining a relative position of the skill indicator, where the second game screen is determined by the virtual camera in the second camera orientation; and in response to an end of the trigger operation, controlling the target virtual character to release the skill in the release region indicated by the skill indicator.

### CROSS REFERENCE TO RELATED APPLICATIONS

The present application is a National Stage Application of International Application No. PCT/CN2023/100822 filed on Jun. 16, 2023 which is based upon and claims the priority of Chinese Patent Application No. 202211071831.9 entitled “Releasing method for a skill in a game, apparatus, electronic device, and readable storage medium”, filed on Sep. 1, 2022, the entire contents of both of which are incorporated herein by reference for all purposes.

### TECHNICAL FIELD

The present disclosure relates to the field of game technology, and in particular, to a releasing method for a skill in a game, an apparatus, an electronic device, and a readable storage medium.

### BACKGROUND

In a game, a virtual character may complete an attack on an enemy virtual character by releasing a skill to the enemy virtual character belonging to an enemy camp. In order to ensure the accuracy of releasing the skill, a skill release region may be indicated by enabling a skill indicator, so that the player may more accurately determine whether the enemy virtual character may be attacked when the skill is released.

In the related art, the player may control the skill indicator to move; however, if the player is unable to perform good control of the movement distance in the operation process, it may result in that the skill indicator exceeds the display range of the graphical user interface. Therefore, the view field of the skill release region is insufficient, the player cannot observe whether the enemy virtual character is located in the skill release region, so that the player cannot release the skill accurately, resulting in failure of the game task and a lower human-computer interaction efficiency.

### SUMMARY

In a first aspect, according to some embodiments of the present disclosure, there is provided a releasing method for a skill in a game, where a graphical user interface is provided by a terminal device, the graphical user interface includes a first game screen of a game scene shot by a virtual camera in a first camera orientation, the virtual camera is provided at a fixed position relative to a target virtual character, and the releasing method includes:
in response to a trigger operation for a target skill, displaying a skill indicator corresponding to the target skill in the graphical user interface, and controlling the skill indicator to follow the trigger operation and move in the graphical user interface, where the skill indicator is configured to indicate a release region for a skill;
in response to the skill indicator moving to an edge position of the graphical user interface, adjusting a camera orientation of the virtual camera from the first camera orientation to a second camera orientation according to the trigger operation for the target skill, and adjusting the first game screen to a second game screen while maintaining a relative position of the skill indicator in the graphical user interface, where the second game screen is determined by the virtual camera shooting on the game scene in the second camera orientation; and
in response to an end of the trigger operation for the target skill, controlling the target virtual character to release the skill in the release region indicated by the skill indicator.

In a second aspect, according to another optional embodiment of the present disclosure, there is provided an electronic device, including: a processor, a storage medium, and a bus; where the storage medium stores a machine-readable instruction executable by the processor; and when the electronic device runs, the processor communicates with the storage medium through the bus, and the processor executes the machine-readable instruction to perform the steps of the releasing method for a skill in a game according to any one of the first aspect.

In a third aspect, according to another optional embodiment of the present disclosure, there is provided a computer-readable storage medium, where the computer-readable storage medium stores a computer program, and when the computer program is run by a processor, the steps of the releasing method for a skill in a game according to any one of the first aspect are performed. In order to make the above objectives, features and advantages of the present disclosure more obvious and understandable, the following detailed description is given with reference to the accompanying drawings.

### BRIEF DESCRIPTION OF THE DRAWINGS

In order to more clearly illustrate the technical solutions of the embodiments of the present disclosure, the accompanying drawings required to be used in the embodiments are briefly described below. It should be understood that the following drawings only show certain embodiments of the present disclosure, and therefore, should not be considered as limitations of the scope. For those of ordinary skill in the art, other related drawings may be obtained according to these drawings without creative efforts.

FIG. 1 is a flowchart of a releasing method for a skill in a game provided according to some embodiments of the present disclosure;

FIG. 2 is a first schematic diagram of a graphical user interface provided according to some embodiments of the present disclosure;

FIG. 3 is a second schematic diagram of a graphical user interface provided according to some embodiments of the present disclosure;

FIG. 4 is a first schematic top view of virtual camera adjustment provided according to some embodiments of the present disclosure;

FIG. 5 is a third schematic diagram of a graphical user interface provided according to some embodiments of the present disclosure;

FIG. 6 is a fourth schematic diagram of a graphical user interface provided according to some embodiments of the present disclosure;

FIG. 7 is a second schematic top view of virtual camera adjustment provided according to some embodiments of the present disclosure;

FIG. 8 is a fifth schematic diagram of a graphical user interface provided according to some embodiments of the present disclosure;

FIG. 9 is a sixth schematic diagram of a graphical user interface provided according to some embodiments of the present disclosure;

FIG. 10 is a third schematic top view of virtual camera adjustment provided according to some embodiments of the present disclosure;

FIG. 11 is a seventh schematic diagram of a graphical user interface provided according to some embodiments of the present disclosure;

FIG. 12 is a first schematic structural diagram of a releasing apparatus for a skill in a game provided according to some embodiments of the present disclosure;

FIG. 13 is a second schematic structural diagram of a releasing apparatus for a skill in a game provided according to some embodiments of the present disclosure;

FIG. 14 is a schematic structural diagram of an electronic device provided according to some embodiments of the present disclosure.

### DETAILED DESCRIPTION

In order to make the objectives, technical solutions, and advantages of the embodiments of the present disclosure clearer, the technical solutions in the embodiments of the present disclosure will be clearly and completely described below with reference to the accompanying drawings in the embodiments of the present disclosure. Obviously, the described embodiments are only a part of the embodiments of the present disclosure, not all of the embodiments of the present disclosure. Components in the embodiments of the present disclosure generally described and illustrated in the drawings here may be arranged and designed in a variety of different configurations. Therefore, the following detailed description of the embodiments of the present disclosure provided in the accompanying drawings is not intended to limit the scope of the present disclosure, but merely represents selected embodiments of the present disclosure. Based on the embodiments of the present disclosure, each other embodiment obtained by those skilled in the art without creative efforts shall fall within the protection scope of the present disclosure.

In some embodiments, the game scene is a virtual scene displayed (or provided) when an application runs on a terminal or a server. Optionally, the game scene is a simulation environment of the real world, or a semi-simulation semi-fictional virtual environment, or a purely fictional virtual environment. The game scene is any one of a two-dimensional virtual scene, a 2.5-dimensional virtual scene, and a three-dimensional virtual scene. The game scene may be sky, land, ocean, or the like, where the land includes environmental elements such as a desert and a city. In some embodiments, the game scene is a scene in which the player controls the complete game logic of the virtual character. For example, in a sandbox 3D shooting game, the game scene is a 3D game world for a player to control a virtual object to perform battle, and the example game scene may include at least one element of a mountain, a plain, a river, a lake, an ocean, a desert, a sky, a plant, a building, and a vehicle. For example, in a 2D or 2.5D card game, the game scene is a scene for displaying release of a card or displaying a virtual object corresponding to the card, and the example game scene may include a platform field, a battle field, or other “field” elements that may display a card battle status, or other elements. In a 2D or 2.5 D multiplayer online tactical competition game, the game scene is a 2D or 2.5D terrain scene for a virtual object to perform battle, and the example game scene may include elements such as a mountain vein of a canyon style, a path, a river, a classroom, a table and chair, a platform, or the like.

In some embodiments, the game interface refers to an interface corresponding to an application provided or displayed through a graphical user interface, and the interface includes a game screen and a UI interface for the player to perform interaction. In some embodiments, the UI interface may include a game control (such as, a skill control, a movement control, a function control, etc.), an indication identifier (such as a direction indication identifier, a character indication identifier, etc.), an information (such as quantity of those being killed, a competition time, etc.) display region, or a game setting control (such as a system setting, a store, a gold coin, etc.). In some embodiments, the game screen is a display screen corresponding to the virtual scene displayed by the terminal device, and the game screen may include a virtual object such as a game character, an NPC character, and an AI character for executing the game logic in the virtual scene.

In some embodiments, the virtual object refers to a dynamic object that may be controlled in a virtual scene. Optionally, the dynamic object may be a virtual character, a virtual animal, an animation character, or the like. The virtual object is a character controlled by a player through an input device, or is an artificial intelligence (AI) provided in a virtual environment battle by training, or is a non-player character (NPC) provided in a virtual scene battle. Optionally, the virtual object is a virtual character for performing competition in a virtual scene. Optionally, a quantity of virtual objects in the virtual scene battle is preset, or is dynamically determined based on a quantity of clients joining the battle, which is not limited in the embodiments of the present disclosure. In some embodiments, the user may control the virtual object to move in the virtual scene, for example, may control the virtual object to run, jump, crawl, etc., and may also control the virtual object to battle with other virtual objects by using a skill, a virtual prop, or the like provided by the application.

In some embodiments, the player character refers to a virtual object that may be controlled by a player to perform an action in a game environment, which may also be referred to as a player virtual character or a player virtual object, and may also be referred to as a shikigami character or a hero character in some electronic games. The player character may be in at least one of different forms such as a virtual character, a virtual animal, a cartoon character, and a virtual carrier.

In some embodiments, in a game, a virtual character may complete an attack on an enemy virtual character by releasing a skill to an enemy virtual character belonging to an enemy camp. In order to ensure the accuracy of releasing the skill, a skill release region may be indicated by enabling a skill indicator, so that the player may more accurately determine whether the enemy virtual character may be attacked when the skill is released.

In the related art, the player may control the skill indicator to move however, if the player is unable to perform good control of the movement distance in the operation process, it may result in that the skill indicator exceeds the display range of the graphical user interface. Therefore, the view field of the skill release region is insufficient, the player cannot observe whether the enemy virtual character is located in the skill release region, so that the player cannot release the skill accurately, resulting in failure of the game task and a lower human-computer interaction efficiency.

In view of the above situation, in the related art, such as in a game with a perspective from top, an implementation in which the focus of the virtual camera follows the position of the hover point for displacement is provided, so that the skill indicator may always be displayed in the graphical user interface. However, the above improvement is provided for the game with a perspective from top. In a game with an oblique perspective at 45 degree, since the virtual camera performs shooting at a fixed position of the target virtual character, the displayed game screen is different from that in a game with a perspective from top, and the display manner in which the focus of the virtual camera follows the position of the hover point for displacement cannot be satisfied. Therefore, in a game with an oblique perspective at 45 degree, there still are problems that the player cannot observe whether the enemy virtual character is located in the skill release region and cannot accurately release the skill when the skill indicator moves out of the graphical user interface, resulting in failure of the game task and a lower human-computer interaction efficiency.

Based on this, according to the embodiments of the present disclosure, there is provided a releasing method for a skill in a game, so as to accurately release the skill and improve the human-computer interaction efficiency. Meanwhile, the data processing amount of the terminal device is reduced, the processing burden of the terminal device is reduced, the power consumption of the terminal device is saved, and the performance overhead of the game server is reduced.

To facilitate understanding of the embodiments, a releasing method for a skill in a game, an apparatus, an electronic device, and a readable storage medium provided by embodiments of the present disclosure are described in detail. The embodiments of the present disclosure may be applied to the field of games, for example, games of a Frame per Second (FPS) type or game of a massive multiplayer online (MMO) type. It should be noted that the embodiments of the present disclosure are not limited to the foregoing types of games, and are not limited to the field of games either.

The releasing method for a skill in a game according to one of embodiments of the present disclosure may run on a local terminal device or a server. When the releasing method for a skill in a game runs on a server, the method may be implemented and performed based on a cloud interaction system, where the cloud interaction system includes a server and a client device.

In some embodiments, various cloud applications may be run in the cloud interaction system, such as a cloud game. Taking a cloud game as an example, the cloud game refers to a game mode based on cloud computing. In the running mode of the cloud game, the running body of the game program and the game screen presentation body are separated. The storage and running of the releasing method for a skill in a game are completed on the cloud game server, and the client device is used for receiving and sending of data and game screen presentation. For example, the client device may be a display device with a data transmission function close to the user side, such as a mobile terminal, a television, a computer, a palmtop computer, or the like. However, it is the cloud game server in the cloud that performs information processing. During the game, the player operates the client device to send an operation instruction to the cloud game server; and the cloud game server runs the game according to the operation instruction, encodes and compresses the data such as the game screen, returns the data to the client device through the network, and finally decodes the data and outputs the game screen through the client device.

In some embodiments, taking a game as an example, the local terminal device stores a game program and is configured to present a game screen. The local terminal device is configured to perform interaction with the player through a graphical user interface, that is, to download and install the game program conventionally through an electric device and run the game program. The manner in which the local terminal device provides the graphical user interface to the player may include a plurality of manners. For example, the graphical user interface may be rendered and displayed on a display screen of the terminal, or provided to the player by holographic projection. For example, the local terminal device may include a display screen and a processor, and the display screen is configured to present a graphical user interface. The graphical user interface includes a game screen. The processor is configured to run the game, generate a graphical user interface, and control display of the graphical user interface on the display screen.

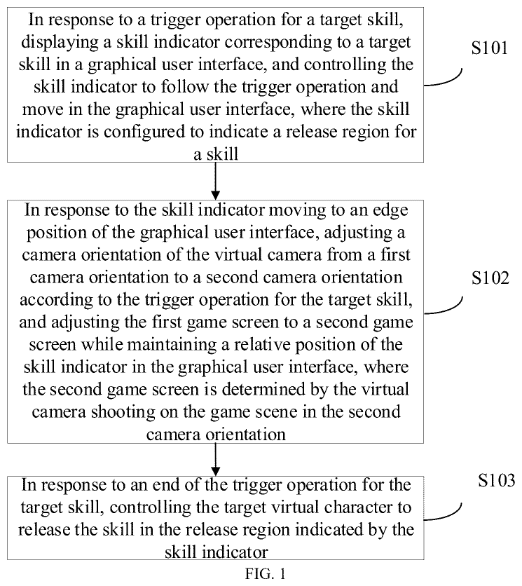

In some embodiments, according to an embodiment of the present disclosure, there is provided a releasing method for a skill in a game, and a graphical user interface is provided by using a terminal device, where the terminal device may be the foregoing local terminal device (for example, a local touch terminal), or may be a client device in the foregoing cloud interaction system. The following description is given by taking an example that the releasing method for a skill in the game runs on a local terminal device (hereinafter referred to as a terminal device). Referring to FIG. 1, FIG. 1 is a flowchart of a releasing method for a skill in a game provided according to some embodiments of the present disclosure. As shown in FIG. 1, the releasing method for a skill in a game provided according some embodiments of the present disclosure includes following steps.

In S101, in response to a trigger operation for a target skill, a skill indicator corresponding to the target skill is displayed in the graphical user interface, and the skill indicator is controlled to follow the trigger operation and move in the graphical user interface, where the skill indicator is configured to indicate a release region of a skill.

In S102, in response to the skill indicator moving to an edge position of the graphical user interface, a camera orientation of the virtual camera is adjusted from a first camera orientation to a second camera orientation according to the trigger operation for the target skill, and the first game screen is adjusted to a second game screen while keeping the relative position of the skill indicator in the graphical user interface unchanged, where the second game screen is a screen determined by the virtual camera shooting on the game scene in the second camera orientation.

In S103, in response to an end of a trigger operation for the target skill, the target virtual character is controlled to release a skill in the release region indicated by the skill indicator.

According to the releasing method for a skill in a game provided by the present disclosure, in the process of controlling a skill indicator to move according to a trigger operation for a target skill, if the skill indicator moves to an edge position of the graphical user interface, the orientation of the virtual camera may be adjusted, and then the game screen displayed on the graphical user interface may be adjusted, so that the skill indicator is always displayed in the graphical user interface, and the skill may be accurately released according to the skill release region indicated by the skill indicator, which is conducive to improving the human-computer interaction efficiency. Meanwhile, the skill indicator adjustment and the virtual camera orientation adjustment are simplified into one adjustment step, which reduces the data processing amount of the terminal device, thus reducing the processing burden of the terminal device, saving the power consumption of the terminal device, and reducing the performance overhead of the game server.

The example steps in the present disclosure are described below.

In S101, in response to a trigger operation for a target skill, a skill indicator corresponding to the target skill is displayed in the graphical user interface, and the skill indicator is controlled to follow the trigger operation and move in the graphical user interface, where the skill indicator is configured to indicate a release region of a skill.

In some embodiments of the present disclosure, the game screen displayed on the graphical user interface may be determined according to the virtual game scene shot by the virtual camera, and the displayed game screen is specifically determined according to the orientation of the virtual camera. When the orientation of the virtual camera changes, the game screen on the graphical user interface also changes. In an optional technical solution of the present disclosure, what is currently displayed is a first game screen corresponding to a full or partial game scene shot by the virtual camera in a first camera orientation.

It should be noted that, in some embodiments of the present disclosure, the virtual camera shoots on a game scene at an inclined angle of 45°, and generates a game screen that is displayed in the graphical user interface. Under the shooting angle in the example of the present disclosure, more screens in the view range of the target virtual character are shown in the game screen. Therefore, for the game screen displayed in the image user interface, the full game scene cannot be completely displayed; and for the scene outside the view range of the target virtual character, this part of game scene cannot be displayed in the displayed game screen.

In some embodiments of the present disclosure, the skill indicator in the 3D game scene is configured to indicate a release region for the skill, and the player may select whether to enable the display of the skill indicator by setting before the game. When the player selects to enable the display of the skill indicator by setting, the skill indicator may be displayed in the graphical user interface when the touch operation for the skill is received, so as to prompt the release region for the skill currently to be released to the player.

In some embodiments, the release region for the skill indicated by the skill indicator includes a release position of the skill and a skill release range. When the enemy virtual character that the target virtual character currently wants to attack is within the skill release range corresponding to the skill indicator, the corresponding skill is released, and the enemy virtual character is attacked by the skill of the target virtual character.

In some embodiments, the displayed shape (such as, a circle, a rectangle, an irregular pattern, etc.), or the displayed color of the skill indicator in the graphical user interface may be rendered and set according to the setting of the game itself, which is not specifically limited in the optional embodiments of the present disclosure.

In an optional example of the present disclosure, after receiving the trigger operation for the target skill, the skill indicator may be displayed in the graphical user interface, and the skill indicator may be controlled to follow the trigger operation and move in the graphical user interface according to the trigger operation for the target skill, so as to ensure that the position where the skill is released is accurate (that is, the enemy virtual character may be attacked).

In an optional example of the present disclosure, for different game types, the target skill may be triggered in different manners, and then the movement of the skill indicator in the graphical user interface may be controlled in different control manners. In some embodiments, the player may control the movement of the skill indicator in the graphical user interface by using a function control and/or a preset combination key. In some embodiments, the player may use the touch function control such as a finger or a mouse, or a preset combination key in the game controller, such as an L1 key and an R1 key in the game handle, or a preset combination key in the keyboard, such as the CTRL key, the ALT key, and the key in the keyboard. The preset key may be manually set according to the player's requirements.

It should be noted that, taking that the trigger operation for the target skill is used as the touch operation on the skill control on the graphical user interface as an example, in the actual game operation process, the operation position of the touch operation of the player (taking a mobile game as an example, the operation position being the position where a finger is located) may be out of the touch response range of the skill control (for the above example, the position of the finger being away from the skill control). In this case, if the player wants to continue controlling the corresponding action through the touch operation on the skill control, the operation position needs to be moved back to the touch response range of the skill control from the current position. Assuming that the touch position is located in the upper left corner of the graphical user interface, and the skill control is generally set in the lower right corner of the graphical user interface, it is needed to complete an adjustment operation by crossing the entire graphical user interface from the upper left corner. Therefore, the player needs to repeatedly perform the touch movement operation, and the control efficiency is relatively lower.

In view of this, in order to ensure the convenience and operation efficiency of the operation of the player in the game process, in some embodiments of the present disclosure, a control following mechanism is provided, so that the skill control may be controlled to follow the touch operation of the player and perform movement. The player may complete corresponding control by operating the skill control in real time.

In some embodiments, the step of “in response to the trigger operation for the target skill, controlling the skill indicator to follow the trigger operation and move in the graphical user interface” includes following steps.

In a1, in response to the touch operation for the skill control, it is detected whether a distance between a touch position of the touch operation and a preset position of the skill control exceeds a preset distance.

In a2, if the distance between the touch position of the touch operation and the preset position of the skill control is greater than the preset distance threshold, the skill control is controlled to follow the touch operation and move in the graphical user interface, and the skill indicator is controlled in real time to follow the touch operation and move in the graphical user interface according to the touch operation for the skill control.

In some embodiments of the present disclosure, when the distance between the current touch position of the touch operation and the preset position of the skill control exceeds the preset distance, the skill control is controlled to follow the touch operation and perform movement. If there is a need to adjust the position movement of the skill indicator, an operation may be performed on the skill control directly at the current position without returning to the original position of the skill indicator to complete the operation, thus improving the efficiency of performing the corresponding control by using the touch operation.

In some embodiments, the preset position of the skill control may be the center position of the skill control. When the distance between the touch position of the touch operation and the center position of the skill control is greater than the preset distance threshold, it may be considered that the current touch position is not on the skill control. In this case, the skill control needs to be controlled to follow the touch operation and perform movement.

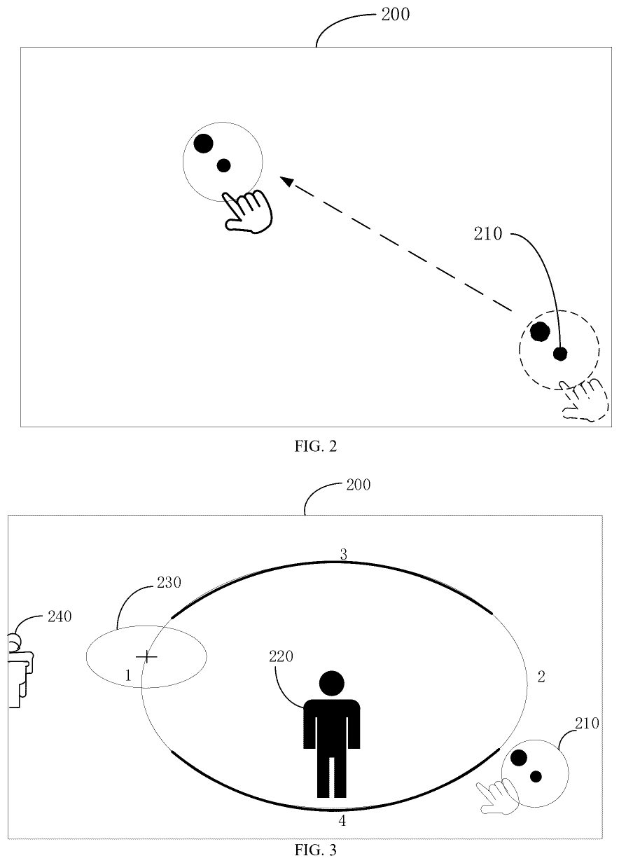

For example, taking the game being a mobile game (in which the player uses their fingers to perform touch operations on the skill control and control the release of the skill) as an example, the process of following and movement of the skill control is illustrated. Referring to FIG. 2, FIG. 2 is a first schematic diagram of a graphical user interface provided according to some embodiments of the present disclosure. As shown in FIG. 2, there is a skill control 210 displayed in the lower right corner of the graphical user interface 200, and the control range (a right rocker) of the skill control 210 is as shown. When a finger of the player is not on the skill control 210, a touch operation range (the right rocker) corresponding to the skill control 210 may follow the finger of the player and perform movement, so that the player may operate the corresponding skill control in real time.

In S102, in response to the skill indicator moving to an edge position of the graphical user interface, a camera orientation of the virtual camera is adjusted from a first camera orientation to a second camera orientation according to the trigger operation for the target skill, and the first game screen is adjusted to a second game screen while keeping the relative position of the skill indicator in the graphical user interface unchanged, where the second game screen is a screen determined by the virtual camera shooting on the game scene in the second camera orientation.

In some embodiments of the present disclosure, the skill indicator may follow the trigger operation for the target skill and move in the graphical user interface. As described above, the display position in the current graphical user interface is relatively limited. Therefore, if the movement range of the trigger operation for the target skill is relatively larger, the skill indicator may be moved to the edge position of the graphical user interface, or even may be directly moved out of the current graphical user interface. In this case, the player cannot observe the specific display range of the skill release range corresponding to the skill indicator; and if the skill is released at this time, it may result in the failure of the skill release (the enemy virtual character being not attacked). Therefore, when the skill indicator moves to the edge position of the graphical user interface, the orientation of the virtual camera needs to be adjusted, so as to simultaneously display the skill indicator and the target virtual character in the second game screen shot by the adjusted virtual camera in an adjusted orientation.

It should be noted that the skill indicator displayed in the game scene is displayed in a 3D environment, while the game screen shot by the virtual camera (including the skill indicator displayed in the game screen) is in a 2D environment. Therefore, when the skill indicator moves to an edge position of the graphical user interface, the conversion from a 3D coordinate to a 2D coordinate needs to be performed first; and then, it is determined whether the skill indicator moves to an edge position of the graphical user interface.

In some embodiments, it is determined by the following steps that the skill indicator moves to an edge position of the graphical user interface.

In step b1, a current three-dimensional coordinate of the skill indicator in the game scene is converted to a current two-dimensional coordinate in a two-dimensional coordinate system where the graphical user interface is located.

In step b2, it is detected, according to the current two-dimensional coordinate, whether a preset overlap condition is satisfied between the skill indicator and an edge position of the graphical user interface; and if the preset overlap condition is satisfied between the skill indicator and an edge position of the graphical user interface, it is determined that the skill indicator moves to an edge position of the graphical user interface.

In some embodiments of the present disclosure, the three-dimensional coordinate of the skill indicator indicating the skill release region in the three-dimensional coordinate system of the game scene needs to be determined; the skill indicator is projected to the two-dimensional coordinate system of the graphical user interface according to a projection formula for conversion from 3D to 2D or according to the way of emitting a ray from the 3D scene, and the current two-dimensional coordinate of the skill indicator is determined; and then, it is determined whether the skill indicator moves to the edge position of the graphical user interface. In some embodiments, there may be a preset boundary line for the graphical user interface. The preset boundary line may be a boundary line of the graphical user interface itself, or may be a boundary line additionally provided in the graphical user interface. It should be noted that, the area of the region enclosed by the boundary line that is additionally provided is less than or equal to the area of the region of the graphical user interface.

In some embodiments, the preset overlap condition may include at least one of the following: an edge of a region of the skill indicator close to the side of the boundary line of the graphical user interface coinciding with a boundary line at an edge position in the graphical user interface; or, a center point of the skill indicator coinciding with a boundary line at an edge position in the graphical user interface.

According to both of the foregoing methods, it may be determined whether the preset overlap condition is satisfied between the skill indicator and the preset boundary line in the first game screen (i.e., the screen that is determined by the virtual camera shooting on the game scene in the first camera orientation). After determining that the preset overlap condition is satisfied between the skill indicator and the preset boundary line in the first game screen, it is determined that the skill indicator has moved to the edge position of the graphical user interface. Then, an adjustment parameter of the virtual camera orientation may be determined according to the edge position of the graphical user interface where the skill indicator is located and an operation direction of the trigger operation for the target skill.

In some embodiments, the step of “adjusting the camera orientation of the virtual camera from the first camera orientation to the second camera orientation according to the trigger operation for the target skill” includes the following step.

In step c1, a rotation parameter and/or a movement parameter of the virtual camera are determined according to an edge position of the graphical user interface where the skill indicator is located and an operation direction of a touch operation for the skill control.

In some embodiments of the present disclosure, the camera orientation of the virtual camera may be determined by a rotation parameter and/or a movement parameter (a movement parameter in a vertical direction) of the virtual camera. In some embodiments, different orientation adjustment manners for the virtual camera may be determined according to the edge position of the graphical user interface where the skill indicator is currently located. The edge positions of the graphical user interface may be classified into left and right edge positions of the graphical user interface, upper and lower edge positions of the graphical user interface, and corner positions of the graphical user interface. The determination manners of determining different parameters corresponding to the orientation adjustment of the virtual camera will be described below according to different edge positions of the graphical user interface where the skill indicator is located.

In a first manner, when the current position of the skill indicator is at the left edge position or the right edge position of the graphical user interface, the rotation parameter of the virtual camera is determined according to the following steps.

In step d1, when the skill indicator is located at the left edge position or the right edge position of the graphical user interface, a rotation angle of the virtual camera is determined according to a movement distance that the trigger operation continues to move leftwards or rightwards.

In step d2, a rotation direction of the virtual camera is determined according to a direction of the edge position where the skill indicator is located in the graphical user interface.

In step d3, the rotation angle and the rotation direction are determined as the rotation parameter. In some embodiments of the present disclosure, when the current position of the skill indication region is located at the left edge position or the right edge position of the graphical user interface, it is needed to control the virtual camera to perform rotation adjustment, so as to adjust the current shooting angle of the virtual camera, so that the skill indicator is displayed in the game screen shot by the virtual camera with an adjusted orientation.

In some embodiments, the rotation adjustment of the virtual camera is divided into the adjustment of the rotation angle of the virtual camera and the adjustment of the rotation direction of the virtual camera. The rotation adjustment of the virtual camera is jointly performed according to the rotation direction and the rotation angle.

In some embodiments, a mapping relationship between the movement distance of the trigger operation and the rotation angle of the virtual camera may be preset. After it is determined that the skill indicator moves to the left edge/right edge of the graphical user interface, the movement distance that the trigger operation continues to move leftwards or rightwards is determined, and then the rotation angle of the virtual camera is determined according to the preset mapping relationship between the movement distance and the rotation angle of the virtual camera.

For example, taking that the trigger operation for the target skill is a touch operation on a skill control as an example, the movement distance of the trigger operation may be calculated according to the distance between the current position of the touch operation and the center position of the skill control. In some embodiments, the distance between the current position of the touch operation and the center position of the skill control may be represented by pixels; and then, the preset mapping relationship between the movement distance of the touch operation and the rotation angle of the virtual camera may be set as that, for every pixel the touch operation moves by, the virtual camera needs to rotate by 1°.

In some embodiments, the rotation direction of the virtual camera may be determined according to the edge position of the graphical user interface where the skill indicator is currently located. This is because the purpose of the present disclosure is to make the skill indicator always be completely displayed in the graphical user interface. When the skill indicator moves to the left edge position or the right edge position of the graphical user interface, in order to make the skill indicator always be displayed in the graphical user interface, the virtual camera needs to be adjusted in the opposite direction. That is, if the skill indicator moves to the left edge position of the graphical user interface, the rotation direction of the virtual camera is rightward; and similarly, if the skill indicator moves to the right edge position of the graphical user interface, the rotation direction of the virtual camera is leftward.

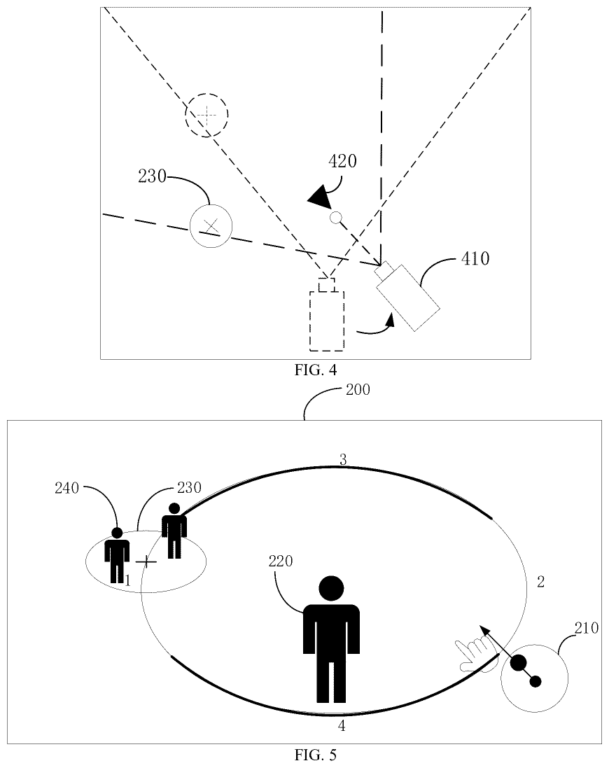

For example, it is taken that the trigger operation for the target skill is a touch operation for a skill control in the graphical user interface as an example. Referring to FIG. 3 to FIG. 5, FIG. 3 is a second schematic diagram of a graphical user interface provided according to some embodiments of the present disclosure, FIG. 4 is a first schematic top view of virtual camera adjustment provided according to some embodiments of the present disclosure, and FIG. 5 is a third schematic diagram of a graphical user interface provided according to some embodiments of the present disclosure. As shown in FIG. 3, four boundary lines 1 to 4 are provided in the graphical user interface 200, and the target virtual character 220 is displayed in an region enclosed by the four boundary lines; and when the skill indicator 230 moves in the region enclosed by the four boundary lines, the skill indicator 230 will not move out the current graphical user interface. As shown in FIG. 3, in order to ensure that the skill is released at the position of the enemy virtual character 240, it is needed to move the skill indicator 230 towards the left side of the graphical user interface; and when the skill indicator 230 moves to the left boundary line (as shown in the figure, the center position of the skill indicator 230 coincides with the left boundary line), and the operation for the skill control 210 still indicates to control the skill indicator to move leftwards (because the skill indicator has not arrived at the position where the enemy virtual character 240 is located), in this case, it is needed to control the virtual camera to rotate, so that the skill indicator 230 is always displayed in the game screen (the graphical user interface) shot by the virtual camera. As shown in FIG. 4, the virtual camera 410 is located at a fixed position relative to the target virtual character; since it is a top view, the target virtual character is indicated by the character identifier 420 in FIG. 4; when the skill indicator 230 moves to the left boundary of the graphical user interface, the virtual camera needs to rotate towards right by a corresponding angle according to the movement distance of the touch operation for the skill control; and then, the skill indicator 230 also performs corresponding rotation, to ensure that a complete skill indicator 230 is present in the game screen shot by the virtual camera in the second camera orientation after rotation. As shown in FIG. 5, FIG. 5 is a graphical user interface in which the virtual camera 410 is adjusted; in this case, the skill indicator 230 is displayed in the graphical user interface, and the skill indicator 230 has moved to the position where the enemy virtual character 240 is located; and, the enemy virtual character 240 is framed in the skill release range of the skill indicator 230, and then the target virtual character 220 may be controlled to release the skill, to attack the enemy virtual character 240.

It should be noted that the rotation function of the virtual camera may be implemented by adjusting the coordinates or the focus position of the virtual camera, changing the cutting value, or the like.

In a second manner, when the current position of the skill indicator is at the upper edge position or the lower edge position of the graphical user interface, the movement parameter of the virtual camera is determined by the following steps.

In step e1, when the current position of skill indicator is at an upper edge position or a lower edge position of the graphical user interface, the movement distance of the virtual camera is determined according to a movement distance that the trigger operation continues to move upwards or downwards.

In step e2, a movement direction of the virtual camera in a vertical direction is determined according to a direction of the edge position where the skill indicator is located in the graphical user interface.

In step e3, the movement distance and the movement direction are determined as the movement parameter.

In some embodiments of the present disclosure, when the skill indicator moves to the upper edge position or the lower edge position of the graphical user interface, the graphical user interface needs to be zoomed out or zoomed in after the virtual camera moves upward or downward from the current position, so as to ensure that the skill indicator is always displayed in the game screen shot by the virtual camera.

In some embodiments, the movement adjustment of the virtual camera is divided into the adjustment of the movement distance of the virtual camera and the adjustment of the movement direction of the virtual camera. The rotation adjustment of the virtual camera is jointly performed according to the movement distance and the movement direction.

In some embodiments, similarly, a mapping relationship between the movement distance of the touch operation and the movement distance of the virtual camera may be preset. After it is determined that the skill indicator moves to the upper edge/lower edge of the graphical user interface, the movement distance that the trigger operation continues to move upwards or downwards is determined, and then the movement distance of the virtual camera is determined according to the preset mapping relationship between the movement distance of the touch operation and the movement distance of the virtual camera.

Corresponding to the above example, taking that the trigger operation for the target skill is a touch operation on a skill control as an example, the movement distance of the trigger operation may be calculated according to the distance between the current position of the touch operation and the center position of the skill control. In some embodiments, the distance between the current position of the touch operation and the center position of the skill control may be represented by pixels; and then, the preset mapping relationship between the movement distance of the touch operation and the movement distance of the virtual camera may be set as that, for every pixel the touch operation moves by, the virtual camera needs to move by 1 m. In some embodiments, the movement direction of the virtual camera may be determined according to the edge position of the graphical user interface where the skill indicator is currently located. This is because the purpose of the present disclosure is to make the skill indicator always be completely displayed in the graphical user interface. When the skill indicator moves to the upper edge position or the lower edge position of the graphical user interface, in order to make the skill indicator always be displayed in the graphical user interface, the virtual camera needs to be adjusted in the same direction. That is, if the skill indicator moves to the upper edge position of the graphical user interface, the movement direction of the virtual camera is upward (relative to the graphical user interface, it is frontward, and the corresponding image user interface is zoomed in); and similarly, if the skill indicator moves to the lower edge position of the graphical user interface, the movement direction of the virtual camera is downward (relative to the graphical user interface, it is backward, and the corresponding image user interface is zoomed out).

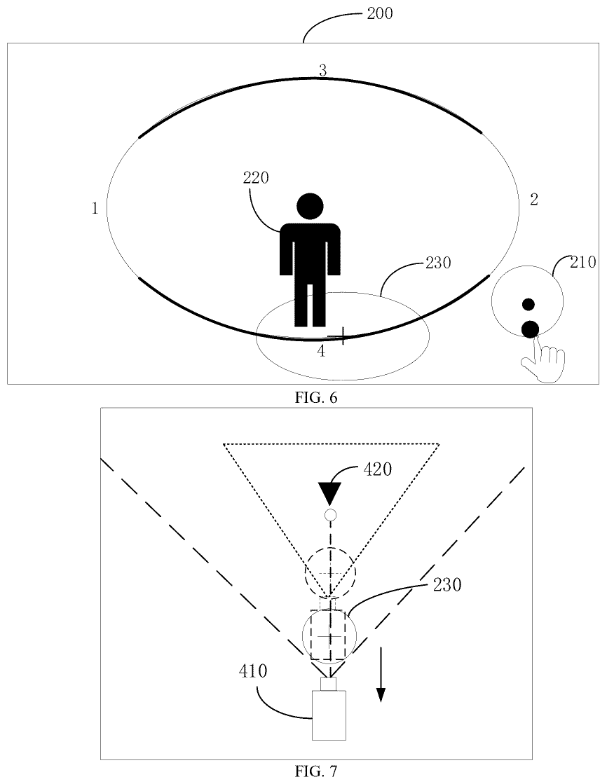

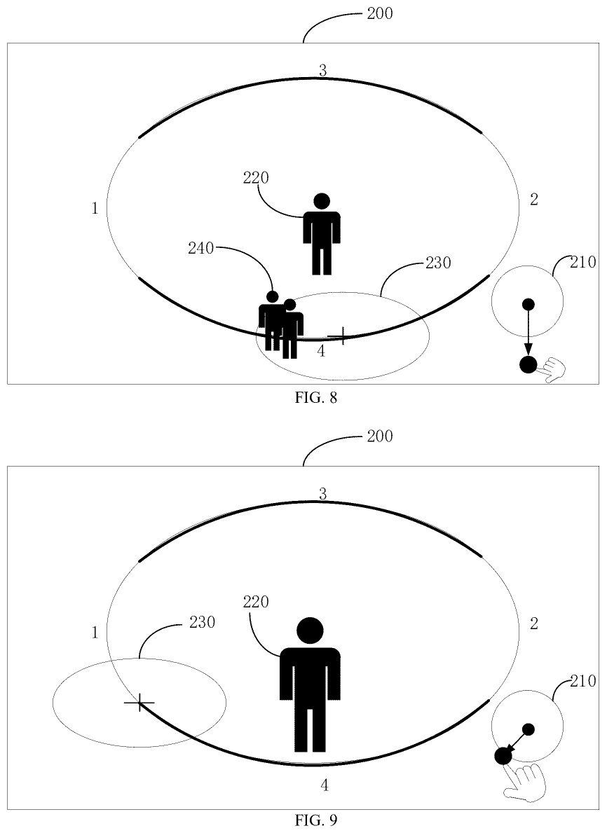

For example, it is taken that the trigger operation for the target skill is a touch operation for a skill control in the graphical user interface as an example. Referring to FIG. 6 to FIG. 8, FIG. 6 is a fourth schematic diagram of a graphical user interface provided according to some embodiments of the present disclosure, FIG. 7 is a second schematic top view of virtual camera adjustment provided according to some embodiments of the present disclosure, and FIG. 8 is a fifth schematic diagram of a graphical user interface provided according to some embodiments of the present disclosure. As shown in FIG. 6, four boundary lines 1 to 4 are provided in the graphical user interface, and the target virtual character 220 is displayed in an region enclosed by the four boundary lines; and when the skill indicator 230 moves in the region enclosed by the four boundary lines, the skill indicator 230 will not move out the current graphical user interface. As shown in FIG. 6, when the current location of the enemy virtual character (not shown in the picture) is detected, the skill indicator needs to continue to move towards the lower boundary of the graphical user interface; and, when the skill indicator 230 moves to the lower boundary line (as shown in the figure, the center position of the skill indicator 230 coincides with the lower boundary line), and the operation for the skill control 210 still indicates to control the skill indicator to move downwards, in this case, it is needed to control the virtual camera to move, so that the skill indicator 230 is always displayed in the game screen (the graphical user interface) shot by the virtual camera. As shown in FIG. 7, similarly, the virtual camera 410 is located at a fixed position relative to the target virtual character; since it is a top view, the target virtual character is indicated by the character identifier 420 in FIG. 7; when the skill indicator 230 moves to the lower boundary of the graphical user interface, the virtual camera needs to retreat downward by a corresponding distance according to the movement distance of the touch operation for the skill control; and then, the skill indicator 230 also performs corresponding movement, to ensure that a complete skill indicator 230 is present in the game screen shot by the virtual camera 410 in the second camera orientation after rotation. As shown in FIG. 8, FIG. 8 is a graphical user interface in which the virtual camera 410 is adjusted; in this case, the skill indicator 230 is displayed in the graphical user interface, and since the virtual camera 410 has moved in the vertical direction, the original graphical user interface is zoomed out; as shown in FIG. 8, the target virtual character 220 is zoomed out; meanwhile, the skill indicator 230 is displayed in the graphical user interface, and the skill indicator 230 has moved to the position where the enemy virtual character 240 is located; and, the enemy virtual character 240 is framed in the skill release range of the skill indicator 230, and then, the target virtual character 220 may be controlled to release the skill, to attack the enemy virtual character 240.

It should be noted that the movement and zoom functions of the virtual camera may be implemented by adjusting the field of view or the focal length of the virtual camera, changing the cutting value, or the like.

In a third manner, when the current position of the skill indicator is located at a corner position of the graphical user interface, the rotation parameter and the movement parameter of the virtual camera are determined simultaneously according to the following steps.

In step f1, when the current position of the skill indicator is located at the corner position of the graphical user interface, a rotation angle and a movement distance of the virtual camera are determined according to a movement distance that trigger operation continues to move.

In step f2, a rotation direction and a movement direction of the virtual camera are determined according to a direction of the corner position where the skill indicator is located in the graphical user interface.

In step f3, the rotation angle and the rotation direction are determined as the rotation parameter, and the movement distance and the movement direction are determined as the movement parameter.

In some embodiments of the present disclosure, when the current position of the skill indicator is located at the corner position of the graphical user interface, it indicates that the skill indicator is currently not only located at the left or rightwards edge position of the graphical user interface but also located at the upper or lower edge position of the graphical user interface. In this case, the virtual camera needs to simultaneously perform rotation operation and displacement operation, to ensure that the skill indicator is always located in the game screen shot by the virtual camera.

In this case, the rotation angle and the movement distance of the virtual camera are determined according to the movement distance that the trigger operation continues to move. According to the edge line of the corner position of the graphical user interface where the current position of the skill indicator is located, the rotation direction and the movement direction of the virtual camera are determined. Then, the rotation parameter of the virtual camera is determined according to the rotation angle and the rotation direction, and the movement parameter of the virtual camera is determined according to the movement direction and the movement distance. And then, adjustments of the virtual camera are simultaneously performed according to the rotation parameter and the movement parameter.

In some embodiments, the determination manner of determining the rotation parameter and the movement parameter of the virtual camera is consistent with the determination manner in the first manner and the second manner, and details are not described here again.

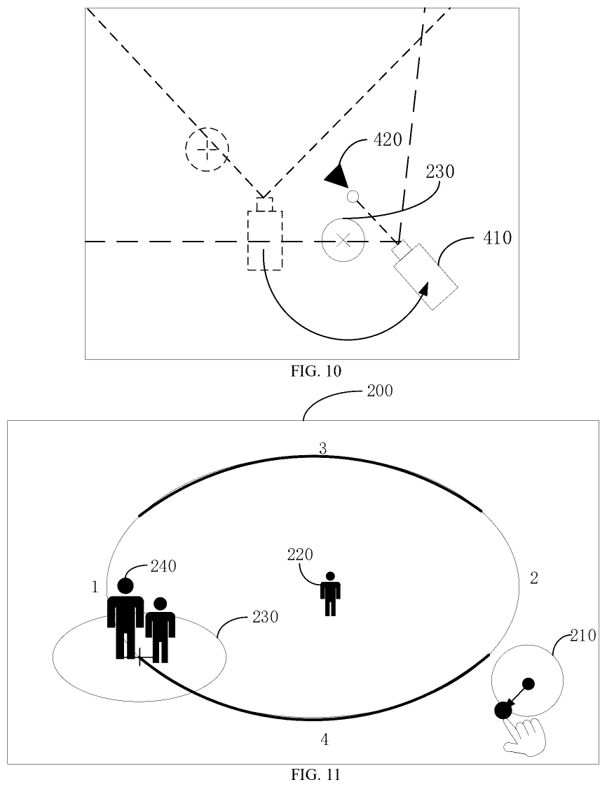

For example, it is taken that the trigger operation for the target skill is a touch operation for a skill control in the graphical user interface as an example. Referring to FIG. 9 to FIG. 11, FIG. 9 is a sixth schematic diagram of a graphical user interface provided according to some embodiments of the present disclosure, FIG. 10 is a third schematic top view of virtual camera adjustment provided according to some embodiments of the present disclosure, and FIG. 11 is a seventh schematic diagram of a graphical user interface provided according to some embodiments of the present disclosure. As shown in FIG. 9, four boundary lines 1 to 4 are provided in the graphical user interface, and the target virtual character 220 is displayed in a region enclosed by the four boundary lines; and when the skill indicator 230 moves in the region enclosed by the four boundary lines, the skill indicator 230 will not move out the current graphical user interface. As shown in FIG. 9, when the current location of the enemy virtual character (not shown in the picture) is detected, the skill indicator needs to continue to move towards the lower left corner of the graphical user interface; and, when the skill indicator 230 moves to the lower left corner (as shown in the figure, the center position of the skill indicator 230 coincides with the left boundary line and the lower boundary line simultaneously), and the operation for the skill control 210 still indicates to control the skill indicator to move downwards and/or leftwards, in this case, it is needed to control the virtual camera to rotate and move, so that the skill indicator 230 is always displayed in the game screen (the graphical user interface) shot by the virtual camera. As shown in FIG. 10, similarly, the virtual camera 410 is located at a fixed position relative to the target virtual character; since it is a top view, the target virtual character is indicated by the character identifier 420 in FIG. 10; when the skill indicator 230 moves to the lower left corner of the graphical user interface, the virtual camera needs to rotate rightwards by a corresponding angle and retreat downwards by a corresponding distance simultaneously according to the movement distance of the touch operation for the skill control; and then, the skill indicator 230 also performs corresponding rotation and movement, to ensure that a complete skill indicator 230 is present in the game screen shot by the virtual camera in the second camera orientation after rotation. As shown in FIG. 11, FIG. 11 is a graphical user interface in which the virtual camera 410 is adjusted; in this case, the skill indicator 230 is displayed in the graphical user interface, and since the virtual camera 410 has also moved in the vertical direction, the original graphical user interface is zoomed out; as shown in FIG. 11, the target virtual character 220 is also zoomed out; meanwhile, the skill indicator 230 is displayed in the graphical user interface, and the skill indicator 230 has moved to the position where the enemy virtual character 240 is located; and, the enemy virtual character 240 is framed in the skill release range of the skill indicator 230, and then, the target virtual character 220 may be controlled to release the skill, to attack the enemy virtual character 240.

In step c2, the camera orientation of the virtual camera is adjusted from the first camera orientation to the second camera orientation according to the rotation parameter and/or the movement parameter of the virtual camera.

In some embodiments of the present disclosure, after the rotation parameter and/or the movement parameter of the virtual camera are determined, the camera orientation of the virtual camera is adjusted from the first camera orientation to the second camera orientation, so that the skill indicator is always located in the graphical user interface, ensuring that the player may observe a complete region of the skill indicator in real time and release the skill accurately to attack the enemy virtual character.

In some embodiments of the present disclosure, in response to a touch operation for the skill control, the skill indicator is controlled to move in the graphical user interface. If the skill indicator has moved to the edge position of the graphical user interface, the movement of the skill indicator on the graphical user interface will no longer be controlled by the touch operation for the skill control; but, by reusing the function of the skill control, the orientation adjustment of the virtual camera is controlled by the touch operation on the skill indicator.

In some embodiments, the step of “in response to the skill indicator moving to the edge position of the graphical user interface, adjusting the camera orientation of the virtual camera from the first camera orientation to the second camera orientation according to the touch operation for the skill control” includes following steps.

In step g1, in response to the skill indicator moving to the edge position of the graphical user interface, it is detected whether the trigger operation for the target skill satisfies a preset control condition; and if the trigger operation for the target skill satisfies the preset control condition, a camera adjustment state is entered.

In step g2, in the camera adjustment state, the camera orientation of the virtual camera is adjusted from the first camera orientation to the second camera orientation according to an operation direction of the trigger operation.

In some embodiments, the preset control condition includes at least one of the following conditions.

The operation direction of the trigger operation for the target skill is a direction in which the skill indicator is controlled to continue to move towards the edge position of the graphical user interface, or an operation distance of the trigger operation for the target skill is greater than a preset operation distance threshold.

In some embodiments of the present disclosure, in response to the skill indicator moving to the edge position of the graphical user interface, if the trigger operation for the target skill satisfied the preset control condition at this time, the camera adjustment state is entered; and in the camera adjustment state, the camera orientation of the virtual camera is adjusted according to the operation direction of the trigger operation for the target skill.

In some embodiments of the present disclosure, when the skill indicator moves to the edge position of the graphical user interface, if the operation direction of the trigger operation for the target skill is the direction in which the skill indicator is controlled to continue to move towards the edge position of the graphical user interface, it indicates that the skill indicator will move out of the graphical user interface when the skill indicator is still controlled according to the trigger operation for the target skill; and at this time, the movement of the skill indicator is no longer controlled according to the trigger operation for the target skill.

In some embodiments, taking that the trigger operation for the target skill is a touch operation on a skill control as an example, the operation direction of the touch operation for the skill control being the direction in which the skill indicator is controlled to continue to move towards the edge position of the graphical user interface, means that the current operation direction of the touch operation is consistent with the direction of the edge position where the skill control is currently located relative to the center position of the graphical user interface.

For example, if the skill indicator is located at the left edge position of the graphical user interface, in this case, the direction of the touch operation for the skill control is leftwards, that is, the skill indicator is controlled to continue to move leftwards; at this time, the skill indicator may move out of the graphical user interface in a great probability, and the virtual camera needs to be adjusted.

Another preset control condition is that, the operation distance of the trigger operation for the target skill is greater than a preset operation distance threshold. The purpose of such setting is to prevent a player from performing an incorrect operation, in which the player adjusts the virtual camera to change the current graphical user interface when there is no need to adjust the virtual camera, which results in that the game screen cannot be accurately observed, thus causing failure in the game.

For example, the preset operation distance threshold may be represented by pixels. For example, only when the operation distance of the re-operation of the player is greater than 5 pixels, the parameter adjustment operation of the virtual camera is triggered.

In some embodiments, to ensure that in the process of adjusting the virtual camera, the game screen viewed from the graphical user interface by the player is that the skill indicator does not move, but only the game scene and the target virtual character move, in some embodiments of the present disclosure, the skill indicator needs to be controlled to rotate or move (consistent with the adjustment of the virtual camera) while adjusting the virtual camera, so as to ensure that the relative position between the skill indicator and the virtual camera remains unchanged. In some embodiments, the skill indicator is displayed in the second game screen, and the position of the skill indicator in the graphical user interface is determined according to the following steps.

In step h1, an updated position of the skill indicator in the graphical user interface is determined according to the rotation parameter and/or the movement parameter of the virtual camera in combination with a relative distance and a relative angle between the skill indicator and the virtual camera.

In step h2, the skill indicator is displayed at the update position in the graphical user interface, to keep the relative position of the skill indicator in the graphical user interface unchanged.

In some embodiments of the present disclosure, the updated position of the skill indicator adjusted in the graphical user interface is determined according to the rotation parameter and/or the movement parameter of the virtual camera in combination with the relative distance and the relative angle between the current skill indicator and the virtual camera. The skill indicator is displayed at the updated position in the graphical user interface to ensure that the relative position between the skill indicator and the virtual camera is unchanged, thus achieving the technical effect that the game screen viewed from the graphical user interface by the player is that the skill indicator does not move, but only the game scene and the target virtual character move.

In S103, in response to an end of a trigger operation for the target skill, the target virtual character is controlled to release the skill in a release region indicated by the skill indicator.

In some embodiments of the present disclosure, when it is determined that the skill indicator only includes a skill release target object (i.e., an enemy virtual character), that is, if the enemy virtual character may be attacked and the virtual character on the player's own side may not be attacked accidently when the skill is released at this time, the skill may be released; and in response to the end of the touch operation for the skill control, the target virtual character is controlled to release the skill in the release region indicated by the skill indicator.

In some embodiments, the end of the trigger operation of the target skill may refer to the end of the current touch operation on the skill control. Taking that the current control is in a mobile game as an example, it refers to that the finger of the player leaves the skill control. It may also refer to that the player ends the press operation on the key on the keyboard. It may also refer to that the player may end the direction control operation on the game handle.

In some embodiments, the occasion for the end of the trigger operation for the target skill may be when the skill indicator moves to the position of the enemy virtual character, and the enemy virtual character is located within the skill release range of the skill indicator. In this case, when the trigger operation for the target skill ends, the target skill is released, and the enemy virtual character may be attacked, ensuring that it is a valid skill release process.

In some embodiments, after the skill release is ended, the orientation of the virtual camera needs to be adjusted back to the first camera orientation before adjustment, so as to continue following game tasks.

In some embodiments, the releasing method further includes the following step.

In step i1, the camera orientation of the virtual camera is adjusted back to the first camera orientation from the second camera orientation.

In some embodiments of the present disclosure, after it is determined that the skill release for the target virtual character is ended, the camera orientation of the virtual camera is adjusted back to the first camera orientation from the second camera orientation, and the first game screen shot by the virtual camera in the first camera orientation is displayed in the graphical user interface. According to corresponding controls, corresponding control operations are performed again.

In the releasing method for a skill in a game provided by the present disclosure, in response to a trigger operation for a target skill, a skill indicator is displayed in the graphical user interface, and the skill indicator is controlled to move according to the trigger operation; when the skill indicator moves to an edge position of the graphical user interface, the camera orientation of the virtual camera is adjusted from a first camera orientation to a second camera orientation according to the trigger operation for the target skill control, and the first game screen is adjusted to the second game screen in the graphical user interface while keeping the relative position of the skill indicator in the graphical user interface unchanged; and in response to the end of the trigger operation for the target skill control, the target virtual character is controlled to release the skill in the release region indicated by the skill indicator. In some embodiments of the present disclosure, in the process of controlling the skill indicator to move according to the trigger operation for the target skill, if the skill indicator moves to an edge position of the graphical user interface, the orientation of the virtual camera may be adjusted, and then the game screen displayed in the graphical user interface may be adjusted, so that the skill indicator is always displayed in the graphical user interface, and the skill may be accurately released according to the skill release region indicated by the skill indicator, which is conducive to improving the human-computer interaction efficiency. Meanwhile, the skill indicator adjustment and the virtual camera orientation adjustment are simplified into one adjustment step, which reduces the data processing amount of the terminal device, thus reducing the processing burden of the terminal device.

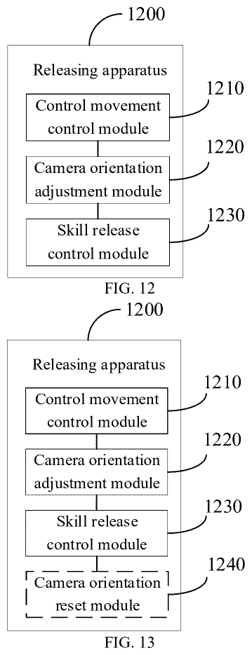

Referring to FIG. 12 and FIG. 13, FIG. 12 is a first schematic structural diagram of a releasing apparatus for a skill in a game provided according to some embodiments of the present disclosure, and FIG. 13 is a second schematic structural diagram of a releasing apparatus for a skill in a game provided according to some embodiments of the present disclosure. As shown in FIG. 12, the releasing apparatus 1200 includes a control movement control module 1210, a camera orientation adjustment module 1220 and a skill release control module 1230.

The control movement control module 1210 is configured to, in response to a trigger operation for a target skill, display a skill indicator corresponding to the target skill in the graphical user interface, and control the skill indicator to follow the trigger operation and move in the graphical user interface, where the skill indicator is configured to indicate a release region for a skill.

The camera orientation adjustment module 1220 is configured to, in response to the skill indicator moving to an edge position of the graphical user interface, adjust a camera orientation of the virtual camera from a first camera orientation to a second camera orientation according to the trigger operation for the target skill, and adjust a first game screen to a second game screen while keeping a relative position of the skill indicator in the graphical user interface unchanged, where the second game screen is a screen determined by the virtual camera shooting on the game scene in the second camera orientation.

The skill release control module 1230 is configured to, in response to an end of the trigger operation for the target skill, control the target virtual character to release a skill in the release region indicated by the skill indicator.

In some embodiments, as shown in FIG. 13, the releasing apparatus 1200 further includes a camera orientation reset module 1240, and the camera orientation reset module 1240 is configured to:
adjust the camera orientation of the virtual camera back to the first camera orientation from the second camera orientation.

In some embodiments, the game scene is a three-dimensional scene; and the camera orientation adjustment module 1220 is configured to determine that the skill indicator moves to an edge position of the graphical user interface according to following steps:
converting a current three-dimensional coordinate of the skill indicator in the game scene to a current two-dimensional coordinate in a two-dimensional coordinate system where the graphical user interface is located; and
detecting, according to the current two-dimensional coordinates, whether a preset overlap condition is satisfied between the skill indicator and the edge position of the graphical user interface; and if the preset overlap condition is satisfied between the skill indicator and the edge position of the graphical user interface, determining that the skill indicator moves to the edge position of the graphical user interface.

In some embodiments, when the camera orientation adjustment module 1220 is configured to adjust the camera orientation of the virtual camera from the first camera orientation to the second camera orientation according to the trigger operation for the target skill, the camera orientation adjustment module 1220 is configured to:
determine a rotation parameter and/or a movement parameter of the virtual camera according to the edge position of the graphical user interface where the skill indicator is located and an operation direction of the trigger operation for the target skill; and
adjust the camera orientation of the virtual camera from the first camera orientation to the second camera orientation according to the rotation parameter and/or the movement parameter of the virtual camera.

In some embodiments, when the skill indicator is located at a left edge position or a right edge position of the graphical user interface, the camera orientation adjustment module 1220 is configured to determine the rotation parameter of the virtual camera according to following steps:
when the skill indicator is located at the left edge position or the right edge position of the graphical user interface, determining a rotation angle of the virtual camera according to a movement distance that the trigger operation continues to move leftwards or rightwards; and
determining a rotation direction of the virtual camera according to a direction of the edge position where the skill indicator is located in the graphical user interface; and
determining the rotation angle and the rotation direction as the rotation parameter.

In some embodiments, when the skill indicator is located at an upper edge position or a lower edge position of the graphical user interface, the camera orientation adjustment module 1220 is configured to determine a movement parameter of the virtual camera according to following steps:
when the skill indicator is located at the upper edge position or the lower edge position of the graphical user interface, determining a movement distance of the virtual camera according to a movement distance that the trigger operation continues to move upwards or downwards;
determining a movement direction of the virtual camera in a vertical direction according to a direction of the edge position where the skill indicator is located in the graphical user interface; and
determining the movement distance and the movement direction as the movement parameter.

In some embodiments, when the current position of the skill indicator is located at a corner position of the graphical user interface, the camera orientation adjustment module 1220 is configured to simultaneously determine the rotation parameter and the movement parameter of the virtual camera according to following steps:
when the current position of the skill indicator is located at the corner position of the graphical user interface, determining a rotation angle and a movement distance of the virtual camera according to a movement distance that trigger operation continues to move;
determining a rotation direction and a movement direction of the virtual camera according to a direction of the corner position where the skill indicator is located in the graphical user interface; and
determining the rotation angle and the rotation direction as the rotation parameter, and determining the movement distance and the movement direction as the movement parameter.

In some embodiments, when the camera orientation adjustment module 1220 is configured to, in response to the skill indicator moving to the edge position of the graphical user interface, adjust the camera orientation of the virtual camera from the first camera orientation to the second camera orientation according to the trigger operation for the target skill, the camera orientation adjustment module 1220 is configured to:
in response to the skill indicator moving to the edge position of the graphical user interface, detect whether the trigger operation for the target skill satisfies a preset control condition; if the trigger operation for the target skill satisfies the preset control condition, enter a camera adjustment state; and
in the camera adjustment state, adjust the camera orientation of the virtual camera from the first camera orientation to the second camera orientation according to an operation direction of the trigger operation.

In some embodiments, the preset control condition includes at least one of the following conditions.

The operation direction of the trigger operation for the target skill is a direction in which the skill indicator is controlled to continue to move towards the edge position of the graphical user interface; or, an operation distance of the trigger operation for the target skill is greater than a preset operation distance threshold.

In some embodiments, a skill control is displayed in the graphical user interface. In a case that the trigger operation for the target skill is a touch operation for the skill control, the control movement control module 1210 is configured to, in response to the trigger operation for the target skill, control the skill indicator to follow the trigger operation and move in the graphical user interface, where the control movement control module 1210 is configured to:
in response to the touch operation for the skill control, detect whether a distance between a touch position of the touch operation and a preset position of the skill control exceeds a preset distance threshold; and
if the distance between the touch position of the touch operation and the preset position of the skill control is greater than the preset distance threshold, control the skill control to follow the touch operation and move in the graphical user interface, and control the skill indicator to follow the touch operation and move in the graphical user interface in real time according to the touch operation for the skill control.

In some embodiments, the skill indicator is displayed in the second game screen, and the camera orientation adjustment module 1220 is configured to determine a position of the skill indicator in the graphical user interface according to the following steps:
determining an update position of the skill indicator in the graphical user interface according to the rotation parameter and/or the movement parameter of the virtual camera in combination with a relative distance and a relative angle between the skill indicator and the virtual camera; and
displaying the skill indicator at the updated position in the graphical user interface, to keep the relative position of the skill indicator in the graphical user interface unchanged.

In the releasing apparatus for a skill in a game provided in the present disclosure, in response to a trigger operation for a target skill, a skill indicator is displayed in the graphical user interface, and the skill indicator is controlled to move according to the trigger operation; when the skill indicator moves to an edge position of the graphical user interface, the camera orientation of the virtual camera is adjusted to from a first camera orientation a second camera orientation according to the trigger operation for the target skill control, and the first game screen is adjusted to the second game screen in the graphical user interface while keeping the relative position of the skill indicator in the graphical user interface unchanged; and in response to the end of the trigger operation for the target skill control, the target virtual character is controlled to release the skill in the release region indicated by the skill indicator. In some embodiments of the present disclosure, in the process of controlling the skill indicator to move according to the trigger operation for the target skill, if the skill indicator moves to an edge position of the graphical user interface, the orientation of the virtual camera may be adjusted, and then the game screen displayed in the graphical user interface may be adjusted, so that the skill indicator is always displayed in the graphical user interface, and the skill may be accurately released according to the skill release region indicated by the skill indicator, which is conducive to improving the human-computer interaction efficiency. Meanwhile, the skill indicator adjustment and the virtual camera orientation adjustment are simplified into one adjustment step, which reduces the data processing amount of the terminal device, thus reducing the processing burden of the terminal device.

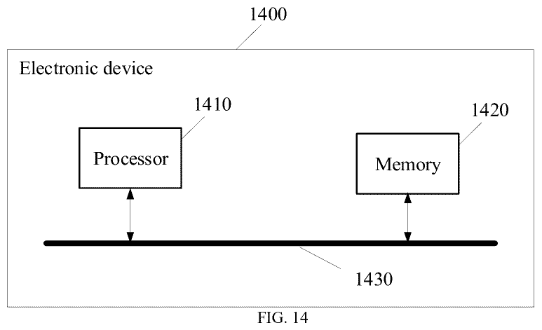

FIG. 14 is a schematic structural diagram of an electronic device provided according to some embodiments of the present disclosure. As shown in FIG. 14, the electronic device 1400 includes a processor 1410, a memory 1420, and a bus 1430.

The memory 1420 stores a machine-readable instruction executable by the processor 1410. When the electronic device 1400 runs, the processor 1410 communicates with the memory 1420 through the bus 1430, to cause the processor 1410 to execute the following steps when running:
in response to a trigger operation for a target skill, displaying a skill indicator corresponding to the target skill in the graphical user interface, and controlling the skill indicator to follow the trigger operation and move in the graphical user interface, where the skill indicator is configured to indicate a release region for a skill;
in response to the skill indicator moving to an edge position of the graphical user interface, adjusting a camera orientation of the virtual camera from a first camera orientation to a second camera orientation according to the trigger operation for the target skill, and adjusting a first game screen to a second game screen while keeping a relative position of the skill indicator in the graphical user interface unchanged, where the second game screen is a screen determined by the virtual camera shooting on the game scene in the second camera orientation; and
in response to an end of a trigger operation for the target skill, controlling the target virtual character to release a skill in the release region indicated by the skill indicator.

In some embodiments, the game scene is a three-dimensional scene; and in the steps executed by the processor 1410, it is determined that the skill indicator moves to the edge position of the graphical user interface according to following steps:
converting a current three-dimensional coordinate of the skill indicator in the game scene to a current two-dimensional coordinate in a two-dimensional coordinate system where the graphical user interface is located; and
detecting, according to the current two-dimensional coordinate, whether a preset overlap condition is satisfied between the skill indicator and the edge position of the graphical user interface; and if the preset overlap condition is satisfied between the skill indicator and the edge position of the graphical user interface, determining that the skill indicator moves to the edge position of the graphical user interface.

In some embodiments, in the steps executed by the processor 1410, the step of adjusting the camera orientation of the virtual camera from the first camera orientation to the second camera orientation according to the trigger operation for the target skill, includes:
determining a rotation parameter and/or a movement parameter of the virtual camera according to the edge position of the graphical user interface where the skill indicator is located and an operation direction of the trigger operation for the target skill; and
adjusting the camera orientation of the virtual camera from the first camera orientation to the second camera orientation according to the rotation parameter and/or the movement parameter of the virtual camera.

In some embodiments, when the skill indicator is located at a left edge position or a right edge position of the graphical user interface, in the steps executed by the processor 1410, the rotation parameter of the virtual camera is determined according to the following steps:
when the skill indicator is located at the left edge position or the right edge position of the graphical user interface, determining a rotation angle of the virtual camera according to a movement distance that the trigger operation continues to move leftwards or rightwards;
determining a rotation direction of the virtual camera according to a direction of the edge position where the skill indicator is located in the graphical user interface; and
determining the rotation angle and the rotation direction as the rotation parameter.

In some embodiments, when the skill indicator is located at an upper edge position or a lower edge position of the graphical user interface, in the steps executed by the processor 1410, the movement parameter of the virtual camera is determined according to the following steps:
when the skill indicator is located at the upper edge position or the lower edge position of the graphical user interface, determining a movement distance of the virtual camera according to a movement distance that the trigger operation continues to move upwards or downwards;
determining a movement direction of the virtual camera in a vertical direction according to a direction of the edge position where the skill indicator is located in the graphical user interface; and
determining the movement distance and the movement direction as the movement parameter.

In some embodiments, when the current position of the skill indicator is located at a corner position of the graphical user interface, in the steps executed by the processor 1410, the rotation parameter and the movement parameter of the virtual camera are determined simultaneously according to the following steps:
when the current position of the skill indicator is located at the corner position of the graphical user interface, determining a rotation angle and a movement distance of the virtual camera according to a movement distance that trigger operation continues to move;
determining a rotation direction and a movement direction of the virtual camera according to a direction of the corner position where the skill indicator is located in the graphical user interface; and
determining the rotation angle and the rotation direction as the rotation parameter, and determining the movement distance and the movement direction as the movement parameter.

In some embodiments, in the steps executed by the processor 1410, the step of in response to the skill indicator moving to the edge position of the graphical user interface, adjusting the camera orientation of the virtual camera from the first camera orientation to the second camera orientation according to the trigger operation for the target skill, includes:
in response to the skill indicator moving to the edge position of the graphical user interface, detecting whether the trigger operation for the target skill satisfies a preset control condition;
if the trigger operation for the target skill satisfies the preset control condition, entering a camera adjustment state; and
in the camera adjustment state, adjusting the camera orientation of the virtual camera from the first camera orientation to the second camera orientation according to an operation direction of the trigger operation;
where the preset control condition includes at least one of:
the operation direction of the trigger operation for the target skill being a direction in which the skill indicator is controlled to continue to move towards the edge position of the graphical user interface, or an operation distance of the trigger operation for the target skill being greater than a preset operation distance threshold.

In some embodiments, a skill control is displayed in the graphical user interface; when the trigger operation for the target skill is a touch operation for the skill control, in the steps executed by the processor 1410, the step of in response to the trigger operation for the target skill, controlling the skill indicator to follow the trigger operation and move in the graphical user interface, includes:
in response to the touch operation for the skill control, detecting whether a distance between a touch position of the touch operation and a preset position of the skill control exceeds a preset distance threshold; and
if the distance between the touch position of the touch operation and the preset position of the skill control is greater than the preset distance threshold, controlling the skill control to follow the touch operation and move in the graphical user interface, and controlling the skill indicator to follow the touch operation and move in the graphical user interface in real time according to the touch operation for the skill control.

In some embodiments, the skill indicator is displayed in the second game screen; and in the steps executed by the processor 1410, the position of the skill indicator in the graphical user interface is determined according to following steps:
determining an update position of the skill indicator in the graphical user interface according to the rotation parameter and/or the movement parameter of the virtual camera in combination with a relative distance and a relative angle between the skill indicator and the virtual camera; and
displaying the skill indicator at the updated position in the graphical user interface, to keep the relative position of the skill indicator in the graphical user interface unchanged.

In some embodiments, the steps executed by the processor 1410 further includes:
adjusting the camera orientation of the virtual camera back to the first camera orientation from the second camera orientation.

In this way, in the process of controlling the skill indicator to move according to the trigger operation for the target skill, if the skill indicator moves to an edge position of the graphical user interface, the orientation of the virtual camera may be adjusted, and then the game screen displayed in the graphical user interface may be adjusted, so that the skill indicator is always displayed in the graphical user interface, and the skill may be accurately released according to the skill release region indicated by the skill indicator, which is conducive to improving the human-computer interaction efficiency. Meanwhile, in the present disclosure, a control following mechanism is provided; when the trigger operation for the target skill is a touch operation for a skill control, the skill control may be controlled to follow the touch operation of the player to move, and the player may complete corresponding controls by operations on the skill control in real time, thus improving the convenience and operation efficiency of the player during the game process. Furthermore, in the present disclosure, there is provided a manner that corresponding operations may be performed only when the operation distance of the trigger operation for the target skill is greater than a preset distance threshold, so as to prevent a player from performing an incorrect operation, and prevent the player from adjusting the virtual camera to change the current graphical user interface when there is no need to adjust the virtual camera, which results in that the game screen cannot be accurately observed, thus causing failure in the game, so that the human-computer interaction efficiency may be further improved. Meanwhile, the skill indicator adjustment and the virtual camera orientation adjustment are simplified into one adjustment step, which reduces the data processing amount of the terminal device, thus reducing the processing burden of the terminal device, saving the power consumption of the terminal device, and reducing the performance overhead of the game server.

According to some embodiments of the present disclosure, there is further provided a computer-readable storage medium, where the computer-readable storage medium stores a computer program, so that when the computer program is run by the processor, the following steps are executed:
in response to a trigger operation for a target skill, displaying a skill indicator corresponding to the target skill in the graphical user interface, and controlling the skill indicator to follow the trigger operation and move in the graphical user interface, where the skill indicator is configured to indicate a release region for a skill;
in response to the skill indicator moving to an edge position of the graphical user interface, adjusting a camera orientation of the virtual camera from a first camera orientation to a second camera orientation according to the trigger operation for the target skill, and adjusting a first game screen to a second game screen while keeping a relative position of the skill indicator in the graphical user interface unchanged, where the second game screen is a screen determined by the virtual camera shooting on the game scene in the second camera orientation; and
in response to an end of a trigger operation for the target skill, controlling the target virtual character to release a skill in the release region indicated by the skill indicator.

In some embodiments, the game scene is a three-dimensional scene; and in the steps executed by the computer-readable storage medium, it is determined that the skill indicator moves to the edge position of the graphical user interface according to the following steps:
converting a current three-dimensional coordinate of the skill indicator in the game scene to a current two-dimensional coordinate in a two-dimensional coordinate system where the graphical user interface is located; and
detecting, according to the current two-dimensional coordinate, whether a preset overlap condition is satisfied between the skill indicator and the edge position of the graphical user interface; and if the preset overlap condition is satisfied between the skill indicator and the edge position of the graphical user interface, determining that the skill indicator moves to the edge position of the graphical user interface.

In some embodiments, in the steps executed by the computer-readable storage medium, the step of adjusting the camera orientation of the virtual camera from the first camera orientation to the second camera orientation according to the trigger operation for the target skill, includes:
determining a rotation parameter and/or a movement parameter of the virtual camera according to the edge position of the graphical user interface where the skill indicator is located and an operation direction of the trigger operation for the target skill; and
adjusting the camera orientation of the virtual camera from the first camera orientation to the second camera orientation according to the rotation parameter and/or the movement parameter of the virtual camera.

In some embodiments, when the skill indicator is located at a left edge position or a right edge position of the graphical user interface, in the steps executed by the computer-readable storage medium, the rotation parameter of the virtual camera is determined according to the following steps:
when the skill indicator is located at the left edge position or the right edge position of the graphical user interface, determining a rotation angle of the virtual camera according to a movement distance that the trigger operation continues to move leftwards or rightwards;
determining a rotation direction of the virtual camera according to a direction of the edge position where the skill indicator is located in the graphical user interface; and
determining the rotation angle and the rotation direction as the rotation parameter.

In some embodiments, when the skill indicator is located at an upper edge position or a lower edge position of the graphical user interface, in the steps executed by the computer-readable storage medium, the movement parameter of the virtual camera is determined according to the following steps:
when the skill indicator is located at the upper edge position or the lower edge position of the graphical user interface, determining a movement distance of the virtual camera according to a movement distance that the trigger operation continues to move upwards or downwards;
determining a movement direction of the virtual camera in a vertical direction according to a direction of the edge position where the skill indicator is located in the graphical user interface; and
determining the movement distance and the movement direction as the movement parameter.

In some embodiments, when the current position of the skill indicator is located at a corner position of the graphical user interface, in the steps executed by the computer-readable storage medium, the rotation parameter and the movement parameter of the virtual camera are determined simultaneously according to the following steps:
when the current position of the skill indicator is located at the corner position of the graphical user interface, determining a rotation angle and a movement distance of the virtual camera according to a movement distance that trigger operation continues to move;
determining a rotation direction and a movement direction of the virtual camera according to a direction of the corner position where the skill indicator is located in the graphical user interface; and
determining the rotation angle and the rotation direction as the rotation parameter, and determining the movement distance and the movement direction as the movement parameter.

In some embodiments, in the steps executed by the computer-readable storage medium, the step of in response to the skill indicator moving to the edge position of the graphical user interface, adjusting the camera orientation of the virtual camera from the first camera orientation to the second camera orientation according to the trigger operation for the target skill, includes:
in response to the skill indicator moving to the edge position of the graphical user interface, detecting whether the trigger operation for the target skill satisfies a preset control condition;
if the trigger operation for the target skill satisfies the preset control condition, entering a camera adjustment state; and
in the camera adjustment state, adjusting the camera orientation of the virtual camera from the first camera orientation to the second camera orientation according to an operation direction of the trigger operation;
where the preset control condition includes at least one of:
the operation direction of the trigger operation for the target skill being a direction in which the skill indicator is controlled to continue to move towards the edge position of the graphical user interface, or an operation distance of the trigger operation for the target skill being greater than a preset operation distance threshold.

In some embodiments, a skill control is displayed in the graphical user interface; when the trigger operation for the target skill is a touch operation for the skill control, in the steps executed by the computer-readable storage medium, the step of in response to the trigger operation for the target skill, controlling the skill indicator to follow the trigger operation and move in the graphical user interface, includes:
in response to the touch operation for the skill control, detecting whether a distance between a touch position of the touch operation and a preset position of the skill control exceeds a preset distance threshold; and
if the distance between the touch position of the touch operation and the preset position of the skill control is greater than the preset distance threshold, controlling the skill control to follow the touch operation and move in the graphical user interface, and controlling the skill indicator to follow the touch operation and move in the graphical user interface in real time according to the touch operation for the skill control.

In some embodiments, the skill indicator is displayed in the second game screen; and in the steps executed by the computer-readable storage medium, the position of the skill indicator in the graphical user interface is determined according to following steps:
determining an update position of the skill indicator in the graphical user interface according to the rotation parameter and/or the movement parameter of the virtual camera in combination with a relative distance and a relative angle between the skill indicator and the virtual camera; and
displaying the skill indicator at the updated position in the graphical user interface, to keep the relative position of the skill indicator in the graphical user interface unchanged.

In some embodiments, the steps executed by the computer-readable storage medium further includes:
adjusting the camera orientation of the virtual camera back to the first camera orientation from the second camera orientation.

In this way, in the process of controlling the skill indicator to move according to the trigger operation for the target skill, if the skill indicator moves to an edge position of the graphical user interface, the orientation of the virtual camera may be adjusted, and then the game screen displayed in the graphical user interface may be adjusted, so that the skill indicator is always displayed in the graphical user interface, and the skill may be accurately released according to the skill release region indicated by the skill indicator, which is conducive to improving the human-computer interaction efficiency. Meanwhile, in the present disclosure, a control following mechanism is provided; when the trigger operation for the target skill is a touch operation for a skill control, the skill control may be controlled to follow the touch operation of the player to move, and the player may complete corresponding controls by operations on the skill control in real time, thus improving the convenience and operation efficiency of the player during the game process. Furthermore, in the present disclosure, there is provided a manner that corresponding operations may be performed only when the operation distance of the trigger operation for the target skill is greater than a preset distance threshold, so as to prevent a player from performing an incorrect operation, and prevent the player from adjusting the virtual camera to change the current graphical user interface when there is no need to adjust the virtual camera, which results in that the game screen cannot be accurately observed, thus causing failure in the game, so that the human-computer interaction efficiency may be further improved. Meanwhile, the skill indicator adjustment and the virtual camera orientation adjustment are simplified into one adjustment step, which reduces the data processing amount of the terminal device, thus reducing the processing burden of the terminal device, saving the power consumption of the terminal device, and reducing the performance overhead of the game server.

It may be clearly understood by those skilled in the art that, for the purpose of convenient and brief description, for the detailed working process of the foregoing system, apparatus, and unit, reference may be made to the corresponding process in the foregoing method embodiments, and details are not described here again.

In the several embodiments provided in the present disclosure, it should be understood that the disclosed system, apparatus, and method may be implemented in other manners. The apparatus embodiments described above are merely illustrative. For example, division of the units is merely a logical function division, and there may be another division manner in actual implementations. For example, a plurality of units or components may be combined or may be integrated into another system, or some features may be ignored or not performed. In addition, the displayed or discussed mutual coupling or direct coupling or communication connection may be an indirect coupling or communication connection between devices or units through some communication interfaces, or may be an electrical connection, mechanical connection or in other forms.

The units described as separate parts may or may not be physically separate. Parts displayed as units may or may not be physical units; that is, they may be located in one position, or may be distributed on a plurality of network units. Some or all of the units may be selected according to actual needs to achieve the objectives of the solutions of the embodiments.

In addition, the various functional units in the embodiments of the present disclosure may be integrated into one processing unit, or each of the units may exist alone physically, or two or more units are integrated into one unit.

When the function is implemented in the form of a software functional unit and sold or used as an independent product, it may be stored in a non-volatile computer-readable storage medium executable by a processor. Based on such understanding, the technical solution of the present disclosure essentially, or the part of the technical solution that contributes to the related art, or a part of the technical solution may be embodied in the form of a software product. The computer software product is stored in a storage medium, and includes several instructions for causing a computer device (which may be a personal computer, a server, or a network device) to perform all or part of the steps of the methods described in the embodiments of the present disclosure. The foregoing storage medium includes any medium that may store program code, such as a USB flash drive, a removable hard disk, a read-only memory (ROM), a random access memory (RAM), a magnetic disk, or an optical disk.

Finally, it should be noted that, the above-mentioned embodiments are only specific implementations of the present disclosure to illustrate the technical solutions of the present disclosure, but not to limit the technical solutions of the present disclosure, and the scope of protection of the present disclosure is not limited to this. Although the present disclosure is described in detail with reference to the foregoing embodiments, those of ordinary skill in the art should understand that, those skilled familiar with art may still modify or change the technical solutions described in the foregoing embodiments or equivalently replace some technical features of the technical features, within the technical scope disclosed in the present disclosure. In addition, these modifications, changes, or replacements do not cause the essence of these technical solutions departing from the spirit and scope of the technical solutions of the embodiments of the present disclosure, and should be covered in the protection scope of the present disclosure. Therefore, the protection scope of the present disclosure shall be subject to the protection scope of the claims.

1. A releasing method for a skill in a game, comprising:
in response to a trigger operation for a target skill, displaying a skill indicator corresponding to the target skill in a graphical user interface, and controlling the skill indicator to follow the trigger operation and move in the graphical user interface, wherein the skill indicator is configured to indicate a release region for a skill, the graphical user interface is provided by a terminal device, the graphical user interface comprises a first game screen of a game scene shot by a virtual camera in a first camera orientation, the virtual camera is provided at a fixed position relative to a target virtual character;
in response to the skill indicator moving to an edge position of the graphical user interface, adjusting a camera orientation of the virtual camera from the first camera orientation to a second camera orientation according to the trigger operation for the target skill, and adjusting the first game screen to a second game screen while maintaining a relative position of the skill indicator in the graphical user interface, wherein the second game screen is determined by the virtual camera shooting on the game scene in the second camera orientation; and
in response to an end of the trigger operation for the target skill, controlling the target virtual character to release the skill in the release region indicated by the skill indicator.

2. The releasing method according to claim 1, wherein the game scene is a three-dimensional scene, and wherein determining that the skill indicator moves to the edge position of the graphical user interface comprises:
converting a current three-dimensional coordinate of the skill indicator in the game scene to a current two-dimensional coordinate in a two-dimensional coordinate system where the graphical user interface is located; and
detecting, according to the current two-dimensional coordinate, whether a preset overlap condition is satisfied between the skill indicator and the edge position of the graphical user interface; and in response to determining that the preset overlap condition is satisfied between the skill indicator and the edge position of the graphical user interface, determining that the skill indicator moves to the edge position of the graphical user interface.

3. The releasing method according to claim 2, wherein adjusting the camera orientation of the virtual camera from the first camera orientation to the second camera orientation according to the trigger operation for the target skill comprises:
determining at least one of a rotation parameter or a movement parameter of the virtual camera according to the edge position of the graphical user interface where the skill indicator is located and an operation direction of the trigger operation for the target skill; and
adjusting the camera orientation of the virtual camera from the first camera orientation to the second camera orientation according to at least one of the rotation parameter or the movement parameter of the virtual camera.

4. The releasing method according to claim 3, wherein, the skill indicator is located at a left edge position or a right edge position of the graphical user interface, and wherein determining the rotation parameter of the virtual camera comprises:
determining a rotation angle of the virtual camera according to a movement distance that the trigger operation continues to move leftwards or rightwards;
determining a rotation direction of the virtual camera according to a direction of the edge position where the skill indicator is located in the graphical user interface; and
determining the rotation angle and the rotation direction as the rotation parameter.

5. The releasing method according to claim 3, wherein, the skill indicator is located at an upper edge position or a lower edge position of the graphical user interface, and wherein determining the movement parameter of the virtual camera comprises:
determining a movement distance of the virtual camera according to a movement distance that the trigger operation continues to move upwards or downwards;
determining a movement direction of the virtual camera in a vertical direction according to a direction of the edge position where the skill indicator is located in the graphical user interface; and
determining the movement distance and the movement direction as the movement parameter.

6. The releasing method according to claim 3, wherein, the skill indicator is located at a corner position of the graphical user interface, and wherein determining the rotation parameter and the movement parameter of the virtual camera simultaneously comprises:
determining a rotation angle and a movement distance of the virtual camera according to a movement distance that trigger operation continues to move;
determining a rotation direction and a movement direction of the virtual camera according to a direction of the corner position where the skill indicator is located in the graphical user interface; and
determining the rotation angle and the rotation direction as the rotation parameter, and determining the movement distance and the movement direction as the movement parameter.

7. The releasing method according to claim 1, wherein, adjusting the camera orientation of the virtual camera from the first camera orientation to the second camera orientation according to the trigger operation for the target skill, comprises:
in response to detecting that the trigger operation for the target skill satisfies a preset control condition, entering a camera adjustment state; and
in the camera adjustment state, adjusting the camera orientation of the virtual camera from the first camera orientation to the second camera orientation according to an operation direction of the trigger operation;
wherein the preset control condition comprises at least one of:
the operation direction of the trigger operation for the target skill being a direction in which the skill indicator is controlled to continue to move towards the edge position of the graphical user interface, or an operation distance of the trigger operation for the target skill being greater than a preset operation distance threshold.

8. The releasing method according to claim 1, wherein a skill control is displayed in the graphical user interface, and the trigger operation for the target skill is a touch operation for the skill control; wherein, in response to the trigger operation for the target skill, controlling the skill indicator to follow the trigger operation and move in the graphical user interface, comprises:
in response to the touch operation for the skill control, detecting whether a distance between a touch position of the touch operation and a preset position of the skill control exceeds a preset distance threshold; and
in response to the distance between the touch position of the touch operation and the preset position of the skill control being greater than the preset distance threshold, controlling the skill control to follow the touch operation and move in the graphical user interface, and controlling the skill indicator to follow the touch operation and move in the graphical user interface in real time according to the touch operation for the skill control.

9. The releasing method according to claim 3, wherein a position of the skill indicator in the graphical user interface is determined according to following steps:
determining an update position of the skill indicator in the graphical user interface according to at least one of the rotation parameter or the movement parameter of the virtual camera in combination with a relative distance and a relative angle between the skill indicator and the virtual camera; and
displaying the skill indicator at the updated position in the graphical user interface, to maintain the relative position of the skill indicator in the graphical user interface.

10. The releasing method according to claim 1, further comprising:
adjusting the camera orientation of the virtual camera back to the first camera orientation from the second camera orientation.

11. (canceled)

12. An electronic device, comprising a processor, a storage medium, and a bus; wherein the storage medium stores a machine-readable instruction executable by the processor; when the electronic device runs, the processor communicates with the storage medium through the bus, and the processor executes the machine-readable instruction to perform a releasing method for a skill in a game, wherein the releasing method comprises:
in response to a trigger operation for a target skill, displaying a skill indicator corresponding to the target skill in a graphical user interface, and controlling the skill indicator to follow the trigger operation and move in the graphical user interface, wherein the skill indicator is configured to indicate a release region for a skill, the graphical user interface is provided by the electronic device, the graphical user interface comprises a first game screen of a game scene shot by a virtual camera in a first camera orientation, the virtual camera is provided at a fixed position relative to a target virtual character;
in response to the skill indicator moving to an edge position of the graphical user interface. adjusting a camera orientation of the virtual camera from the first camera orientation to a second camera orientation according to the trigger operation for the target skill, and adjusting the first game screen to a second game screen while maintaining a relative position of the skill indicator in the graphical user interface, wherein the second game screen is determined by the virtual camera shooting on the game scene in the second camera orientation; and
in response to an end of the trigger operation for the target skill, controlling the target virtual character to release the skill in the release region indicated by the skill indicator.

13. A non-transitory computer-readable storage medium, wherein the non-transitory computer-readable storage medium stores a computer program, and when the computer program is run by a processor, steps of a releasing method for a skill in a game are performed, wherein the releasing method comprises:
in response to a trigger operation for a target skill, displaying a skill indicator corresponding to the target skill in a graphical user interface, and controlling the skill indicator to follow the trigger operation and move in the graphical user interface, wherein the skill indicator is configured to indicate a release region for a skill, the graphical user interface is provided by a terminal device, the graphical user interface comprises a first game screen of a game scene shot by a virtual camera in a first camera orientation, the virtual camera is provided at a fixed position relative to a target virtual character;
in response to the skill indicator moving to an edge position of the graphical user interface, adjusting a camera orientation of the virtual camera from the first camera orientation to a second camera orientation according to the trigger operation for the target skill, and adjusting the first game screen to a second game screen while maintaining a relative position of the skill indicator in the graphical user interface, wherein the second game screen is determined by the virtual camera shooting on the game scene in the second camera orientation; and
in response to an end of the trigger operation for the target skill, controlling the target virtual character to release the skill in the release region indicated by the skill indicator.

14. The electronic device according to claim 12, wherein the game scene is a three-dimensional scene, and wherein determining that the skill indicator moves to the edge position of the graphical user interface comprises:
converting a current three-dimensional coordinate of the skill indicator in the game scene to a current two-dimensional coordinate in a two-dimensional coordinate system where the graphical user interface is located; and
detecting, according to the current two-dimensional coordinate, whether a preset overlap condition is satisfied between the skill indicator and the edge position of the graphical user interface; and in response to determining that the preset overlap condition is satisfied between the skill indicator and the edge position of the graphical user interface, determining that the skill indicator moves to the edge position of the graphical user interface.

15. The electronic device according to claim 14, wherein adjusting the camera orientation of the virtual camera from the first camera orientation to the second camera orientation according to the trigger operation for the target skill, comprises:
determining at least one of a rotation parameter or a movement parameter of the virtual camera according to the edge position of the graphical user interface where the skill indicator is located and an operation direction of the trigger operation for the target skill; and
adjusting the camera orientation of the virtual camera from the first camera orientation to the second camera orientation according to at least one of the rotation parameter or the movement parameter of the virtual camera.

16. The electronic device according to claim 15, wherein, the skill indicator is located at a left edge position or a right edge position of the graphical user interface, and wherein determining the rotation parameter of the virtual camera comprises:
determining a rotation angle of the virtual camera according to a movement distance that the trigger operation continues to move leftwards or rightwards;
determining a rotation direction of the virtual camera according to a direction of the edge position where the skill indicator is located in the graphical user interface; and
determining the rotation angle and the rotation direction as the rotation parameter.

17. The electronic device according to claim 15, wherein, the skill indicator is located at an upper edge position or a lower edge position of the graphical user interface, and wherein determining the movement parameter of the virtual camera comprises:
determining a movement distance of the virtual camera according to a movement distance that the trigger operation continues to move upwards or downwards;
determining a movement direction of the virtual camera in a vertical direction according to a direction of the edge position where the skill indicator is located in the graphical user interface; and
determining the movement distance and the movement direction as the movement parameter.

18. The electronic device according to claim 15, wherein, the skill indicator is located at a corner position of the graphical user interface, and wherein determining the rotation parameter and the movement parameter of the virtual camera simultaneously comprises:
determining a rotation angle and a movement distance of the virtual camera according to a movement distance that trigger operation continues to move;
determining a rotation direction and a movement direction of the virtual camera according to a direction of the corner position where the skill indicator is located in the graphical user interface; and
determining the rotation angle and the rotation direction as the rotation parameter, and determining the movement distance and the movement direction as the movement parameter.

19. The electronic device according to claim 15, wherein a position of the skill indicator in the graphical user interface is determined according to following steps:
determining an update position of the skill indicator in the graphical user interface according to at least one of the rotation parameter or the movement parameter of the virtual camera in combination with a relative distance and a relative angle between the skill indicator and the virtual camera; and
displaying the skill indicator at the updated position in the graphical user interface, to maintain the relative position of the skill indicator in the graphical user interface.

20. The non-transitory computer-readable storage medium according to claim 13, wherein, adjusting the camera orientation of the virtual camera from the first camera orientation to the second camera orientation according to the trigger operation for the target skill, comprises:
in response to detecting that the trigger operation for the target skill satisfies a preset control condition, entering a camera adjustment state; and
in the camera adjustment state, adjusting the camera orientation of the virtual camera from the first camera orientation to the second camera orientation according to an operation direction of the trigger operation;
wherein the preset control condition comprises at least one of:
the operation direction of the trigger operation for the target skill being a direction in which the skill indicator is controlled to continue to move towards the edge position of the graphical user interface, or an operation distance of the trigger operation for the target skill being greater than a preset operation distance threshold.

21. The non-transitory computer-readable storage medium according to claim 13, wherein a skill control is displayed in the graphical user interface, and the trigger operation for the target skill is a touch operation for the skill control; wherein, in response to the trigger operation for the target skill, controlling the skill indicator to follow the trigger operation and move in the graphical user interface, comprises:
in response to the touch operation for the skill control, detecting whether a distance between a touch position of the touch operation and a preset position of the skill control exceeds a preset distance threshold; and
in response to the distance between the touch position of the touch operation and the preset position of the skill control being greater than the preset distance threshold, controlling the skill control to follow the touch operation and move in the graphical user interface, and controlling the skill indicator to follow the touch operation and move in the graphical user interface in real time according to the touch operation for the skill control.
